(19) United States
(12) Patent Application Publication
(10) Pub. No.: US 2020/0013118 A1
(43) Pub. Date: Jan. 9, 2020

(54) DISTRIBUTED LEDGER SYSTEM FOR ANONYMIZED TRANSACTION MANAGEMENT

(71) Applicant: Accenture Global Solutions Limited, Dublin (IE)

(72) Inventors: David B. Treat, Chicago, IL (US); Todd C. Pingaro, San Clemente, CA (US); Nikhil Nayab, Princeton Junction, NJ (US); Christian A. Aldecoa, San Francisco, CA (US)

(21) Appl. No.: 16/028,943

(22) Filed: Jul. 6, 2018

(51) Int. Cl. G06Q 40/04; G06Q 20/38

(52) U.S. Cl. CPC G06Q 40/04; G06Q 20/383

(57) ABSTRACT

Techniques are described for using a distributed ledger system (DLS) to manage transactions such as the trading of assets between entities. In some implementations, a platform provides a mechanism in which multiple institutions can participate in a dark pool for trading assets. The platform employs a DLS to support a dark pool that provides data privacy to the participating institutions, anonymity to the trading entities, data security, immutability, and transparency for auditing and regulatory compliance. Through a dark pool supported by a DLS, multiple institutions can benefit from a shared dark pool, thus increasing the number of parties who can participate in the trading activities, increasing the quantity of assets available to be traded, and increasing the likelihood of matching seller(s) to buyer for a particular trade. The DLS ensures that the information in the dark pool is kept secure and confidential, through homomorphic encryption and/or zero knowledge proof.

### BACKGROUND

Traditionally, the trading of commodities shares, securities, stocks, and/or other assets has occurred through a market. In some instances, banks or other institutions have set up dark pools as an alternative to markets. Traditional dark pools are created and operated by a sell-side bank, for example, as a service to their customers. Typically, large trades are submitted to the dark pool to be matched with other orders as an alternative to sending them to an exchange, where the size of the trade (or even the offer) could move the market price. Through a dark pool, large orders can be fulfilled without moving the market. Recently, problems have arisen in dark pools, through entities using algorithmic and/or high-frequency trading mechanisms to probe dark pools, discover trading patterns, and trade ahead of the discovered patterns.

### SUMMARY

Implementations of the present disclosure are generally directed to transaction management for computer-driven trading of assets between entities. More particularly, implementations of the present disclosure are directed to use of a novel distributed ledger system to provide transaction management for trading assets between entities, in which buyer and/or seller entities' identities are anonymized on the distributed ledger system, and in which access to the distributed ledger system is otherwise controlled to ensure the parties' privacy and prevent use of the dark pool for trading pattern discovery.

In general, implementations of innovative aspects of the subject matter described in this specification can be embodied in a method that includes the following operations: receiving a request to provide items to a requesting entity, the request received from a first computing device that is operated by a first institution associated with the requesting entity, and the request indicating a requested quantity of the items to be provided to the requesting entity; storing, on a distributed ledger system (DLS) that includes multiple host node devices, a request record that describes the request, the request record identifying the requested quantity of the items, the requesting entity, and the first institution; searching the DLS to identify a set of offer records that includes at least one offer record stored on the DLS, each of the set of offer records describing a respective offer to provide items from a respective offering entity associated with a respective second institution, wherein the set of offer records are identified based at least partly on: i) a correspondence between the requested items and the offered items, and ii) a total quantity of the offered items described in the set of offer records being at least the requested quantity of items; and communicating a match notification to the first computing device operated by the first institution and to one or more second computing devices each operated by a respective second institution identified in the set of offer records, the match notification identifying the requesting entity and one or more offering entities identified in the set of offer records, wherein at least one second institution identified in the set of offer records is different from the first institution associated with the requesting entity.

These and other implementations can each optionally include one or more of the following innovative aspects: the DLS stores a plurality of request records that each indicates a respective requested quantity of items, a respective requesting entity, and a respective first institution associated with the respective requesting entity; the DLS stores a plurality of offer records that each indicates a respective offered quantity of items, a respective offering entity, and a respective second institution associated with the respective offering entity; the respective requesting entity, the respective first institution, the respective offering entity, and the respective second institution are anonymized in the request records and the offer records stored on the DLS; the request record further describes a requested price for the items; each offer record further describes an offered price for the items; the match notification further indicates an aggregate price based on the offered price described in the set of offer records; the request record further includes a request time-to-live (TTL); each of the set of offer records further includes a respective offer TTL; identifying the set of offer records further includes verifying that the respective offer TTL in each of the set of offer records has not expired; the operations further include applying a set of rules that govern access to the DLS, including denying requests from a requesting institution based on the requests exceeding maximum request frequency; the operations further include storing, on the DLS, a match record that identifies the requesting entity and the one or more offering entities identified in the set of offer records; the operations further include receiving one or more offers to provide items, each offer received from a respective second computing device that is operated by a second institution associated with a respective offering entity, each offer indicating a respective offered quantity of the items to be provided from the respective offering entity; the operations further include storing, on the DLS, one or more offer records that each describes a respective offer, each offer record identifying the respective offered quantity of the items, the respective offering entity, and the respective second institution associated with the respective offering entity; the set of offer records includes a plurality of offer records; and/or the match notification further identifies, for each of a plurality of offering entities identified in the set of offer records, a respective quantity of the items offered by the respective offering entity.

Other implementations of any of the above aspects include corresponding systems, apparatus, and/or computer programs that are configured to perform the operations of the methods. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

The implementations described herein provide at least the following technical advantages and/or improvements compared to previously available techniques. By using a distributed ledger system for managing trades between entities, implementations incorporate the technical advantages of a distributed ledger including but not limited to data security, identity access control, automation, data immutability, reliability, and distributed storage (e.g., for failover support and storage redundancy).

It is appreciated that implementations in accordance with the present disclosure can include any combination of the aspects and features described herein. That is, implementations in accordance with the present disclosure are not limited to the combinations of aspects and features specifically described herein, but also include any other appropriate combinations of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system for transaction management, according to implementations of the present disclosure.

FIG. 2A depicts an example request record, according to implementations of the present disclosure.

FIG. 2B depicts an example offer record, according to implementations of the present disclosure.

FIG. 2C depicts an example match record, according to implementations of the present disclosure.

FIG. 3 depicts a flow diagram of an example process for handling offers, according to implementations of the present disclosure.

FIG. 4 depicts a flow diagram of an example process for handling requests, according to implementations of the present disclosure.

FIG. 5 depicts an example computing system, according to implementations of the present disclosure.

### DETAILED DESCRIPTION

Implementations of the present disclosure are directed to techniques for using a distributed ledger system (DLS) for managing transactions, such as managing the trading of assets between entities. In some implementations, a platform provides a mechanism in which multiple banks or other institutions can participate in a dark pool for trading securities, stocks, commodities shares, and/or other assets. The platform employs a DLS, such as one or more blockchains, to support a dark pool that provides data privacy to the participating institutions, anonymity to the trading entities (buyers and sellers), data security and immutability, as well as transparency for auditing and regulatory compliance. Through a dark pool supported by a DLS, multiple institutions can benefit from a shared dark pool, thus increasing the number of parties who can participate in the trading activities and increasing the quantity of potential assets available to be matched between buyers and sellers, and thus increasing the likelihood of matching seller(s) to buyer for a particular trade. The DLS provides an improved technique, compared to previously available solutions, to better ensure that the information in the dark pool is kept secure and confidential, through techniques like homomorphic encryption and/or zero knowledge proof. Use of the DLS also provides for increased auditability and/or transparency where appropriate.

The DLS enables the storing and tracking to be performed efficiently and inexpensively. The DLS also provides security, such that only authorized institutions are able to access the data stored on the DLS. The DLS also provides immutability, such that data records written to the DLS may not be changed or removed once written. Implementations address the shortcomings associated with existing dark pool implementations by providing better protection for dark pool information, providing better auditability, providing better transparency into transactions when warranted, and allowing for a larger number of parties to participate in a dark pool to improve market functioning.

In some implementations, access to the DLS can be controlled and mediated by a matching service executing on one or more server devices. The service can receive offers from institutions that have agreed to participate in the dark pool, where each offer is an offer from an entity to sell a particular number of items (e.g., shares, securities, other assets). For each offer received, the service can write a record to the DLS describing the offer. For example, a record can be written to the DLS if the institution's authorization to participate is confirmed and the offer complies with certain applied rule(s) governing participation in the dark pool. Such rule(s) can include confirmation of ownership of the items to be sold. The service can similarly write a record to the DLS for each received request to purchase a particular number of items. In response to a purchase request, the service can search one or more ledgers of the DLS for offer record(s) to assemble the trade from one or more offering entities. Based on successfully matching buyer to seller(s) through use of the records on the DLS, the service can send a notification to the various parties, identifying the matched parties, and enabling the parties to conclude the transaction. The matching logic can execute externally from the DLS (e.g., in the request matching service 104), and/or on the DLS. The system can support any suitable amount of throughput for matching buy and sell requests.

The DLS can also be described as a distributed ledger network (DLN) or distributed ledger technology (DLT). The DLS can be a permissioned DLS, or a permission-less DLS. In some implementations, a permissioned DLS can be employed to facilitate data confidentiality and/or regulatory compliance.

Implementations can facilitate near real-time or real-time settlement of transactions, including payment processing. The DLS can include all the information necessary to allow for settlement of transactions upon completion. For example, the platform can include a real-time settlement engine, as described below. In instances where the account information for participants is stored in the DLS, payment can be made as soon as the transaction is completed.

Implementations also allow for efficient and accurate auditing of transactions and behavior of participants in the dark pool. For example, government or industry auditors can review information on the DLS to ensure compliance with regulations. In addition, algorithms can be used to identify abnormal behavior that could indicate a participant is trying to behave badly, such as trying to monitor activity in the dark pool to place trades outside the dark pool to get ahead of the market.

In some implementations, the DLS includes one or more blockchains. A blockchain is a public or private ledger of all transactions that have been executed in one or more contexts (e.g., negotiable instrument transactions, digital currency transactions, access determinations, instances of providing access, etc.). A blockchain may grow as completed blocks are added with a new set of transactions. In some examples, a single block is provided from multiple transactions (e.g., multiple deposits of different checks by different people). In general, blocks are added to the blockchain in a linear, chronological order by one or more computing devices in a peer-to-peer network of interconnected computing devices that execute a blockchain protocol. In short, the peer-to-peer network can be described as a plurality of interconnected nodes, each node being a computing device (or a cluster of multiple devices) that uses a client to validate and relay transactions. Each node maintains a copy of the blockchain, which is automatically downloaded to the node upon joining the peer-to-peer network. The blockchain protocol provides a secure and reliable method of updating the blockchain, copies of which are distributed across the peer-to-peer network, without use of a central authority.

Because entities on the blockchain network may need to know all previous transactions to validate a requested transaction, all entities may have to agree on which transactions have actually occurred, and in which order. For example, if two entities observe different transaction histories, they will be unable to come to the same conclusion regarding the validity of a transaction. The blockchain enables all entities to come to an agreement as to transactions that have already occurred, and in which order. In short, and as described in further detail below, a ledger of transactions is agreed to based on the amount of work required to add a transaction to the ledger of transactions (e.g., add a block to the blockchain). Blockchains can employ any appropriate proof-of-work mechanism. Blockchains may also employ other protocols. In this context, the work is a task that is difficult for any single node (e.g., computing device) in the peer-to-peer network to quickly complete, but is relatively easy for a node (e.g., computing device) to verify.

The peer-to-peer network includes so-called miners (e.g., computing devices) that add blocks to a blockchain based on the blockchain protocol. In general, multiple miners validate transactions that are to be added to a block, and compete (e.g., perform work, as introduced above) to have their block added to the blockchain. Validation of transactions includes verifying digital signatures associated with respective transactions. For a block to be added to the blockchain, a miner must demonstrate a proof of work before their proposed block of transactions is accepted by the peer-to-peer network, and is added to the blockchain. A blockchain protocol includes a proof of work scheme that is based on a cryptographic hash function (CHF). An example CHF includes the secure hash algorithm 256 (SHA-256). In general, the CHF receives information as input, and provides a hash value as output, the hash value being of a predetermined length. For example, SHA-256 outputs a 256-bit (32-byte, 64-character) hash value. In some examples, the hash value is a one-way hash value, in that the hash value cannot be ‘un-hashed’ to determine what the input was. The blockchain protocol can require multiple pieces of information as input to the CHF. For example, the input to the CHF can include a reference to the previous (most recent) block in the blockchain, details of the transaction(s) that are to be included in the to be created block, and a nonce value (e.g., a random number used only once).

Multiple nodes may compete to hash a set of transactions and provide the next block that is to be added to the blockchain. The blockchain protocol provides a threshold hash to qualify a block to be added to the blockchain. For example, the threshold hash can include a predefined number of zeros (0's) that the hash value must have at the beginning (e.g., at least the first four characters of the hash value must each be zero). The higher the number of zeros, the more time-consuming it is to arrive at a qualifying hash value.

In accordance with the blockchain protocol, each miner in the peer-to-peer network receives transaction information for one or more transactions that are to be included in a block that is to be added next in the blockchain. Each miner provides the reference to the previous (most recent) block in the blockchain, details of the transaction(s) that are to be included in the to-be-created block, and the nonce value to the CHF to provide a hash value. If the hash value does not meet the threshold hash (e.g., the first four characters of the hash value are not each zero), the miner starts again to provide another hash value. If the hash value meets the threshold hash (e.g., at least the first four characters of the hash value are each zero), the respective miner successfully created the next block that is to be added to the blockchain. Consequently, the respective miner's block is broadcast across the peer-to-peer network. All other miners cease work (because one miner was already successful), and all copies of the blockchain are updated across the peer-to-peer network to append the block to the blockchain. Each miner may be required to produce hundreds or thousands of hash values, before any one miner provides a qualifying hash value (e.g., at least the first four characters of the hash value are each zero).

In some cases, the DLS can include one or more sidechains. A sidechain can be described as a blockchain that validates data from other blockchains. In some examples, a sidechain enables ledger assets (e.g., a digital currency, records of shares or other items, etc.) to be transferred between multiple blockchains using a suitable interoperability protocol.

The blockchain may be a public blockchain, such that data stored on the blockchain is generally accessible. The blockchain may be a private blockchain, such that the stored data is accessible only to authorized individuals and/or processes on the blockchain. A private blockchain may be accessible by entities and/or processes that have been authorized to access the blockchain, and any suitable access control mechanism may be employed to control access to the private blockchain. A private blockchain may not require proof of work, and may use other suitable mechanisms for allowing information to be added to the blockchain.

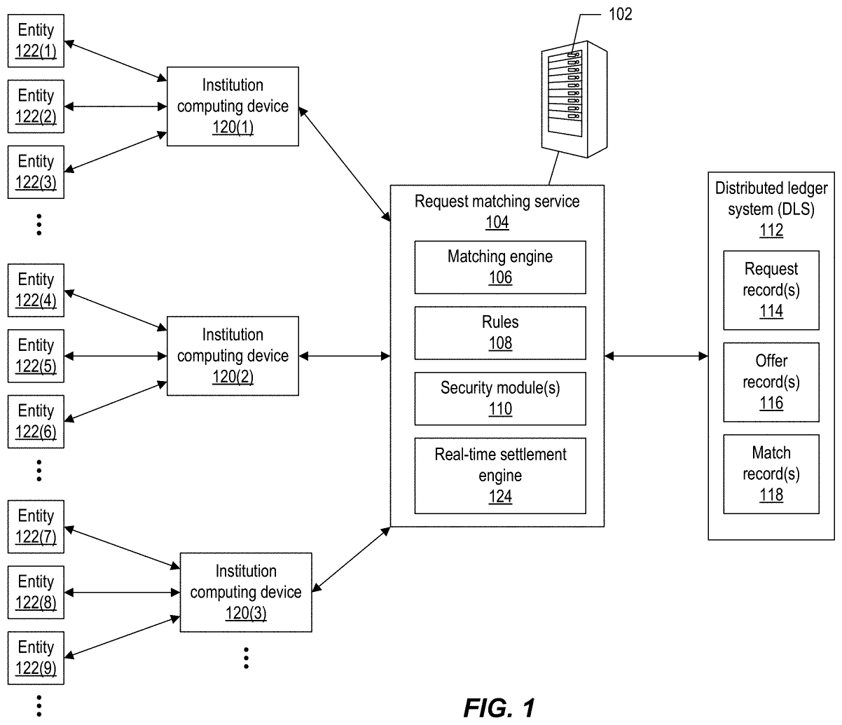

FIG. 1 depicts an example system for transaction management, according to implementations of the present disclosure. As shown in the example of FIG. 1, the system can include one or more server computing devices 102 that host or otherwise support a request matching service 104. The service 104 may communicate, over one or more networks, with a DLS 112. In some instances, the device(s) 102 operate as node(s) that host the DLS 112. The service 104 can include a matching engine 106 that operates to match buyer(s) with seller(s), rules 108 that govern the matching operations, and security module(s) 110 that govern access to the service 104 and/or the DLS 112. The security module(s) 110 can verify that institutions submitting sell offers or buy requests (orders) are authorized to participate in the dark pool. In some implementations, the security module(s) 110 can also verify that a seller owns the items being offered for sale. In some implementations, at least a portion of the service 104 can be implemented as one or more smart contracts that execute on the DLS 112 or separately from the DLS 112. The server(s) 102, service 104, and DLS 112, provide a dark pool for item (e.g., asset) trading between entities, and may also be described collectively as the platform or the dark pool platform.

In some implementations, the service 104 can include a real-time settlement engine 124 that performs operations for real-time settlement between buyer and seller following approval of a trade. The settlement can be performed in real-time, or substantially in real-time, following approval of the trade, and can use account information for buyer and seller that is stored on the DLS or elsewhere. The real-time settlement can include sending a request to perform a funds transfer from an account of the buyer to an account of the seller, using any suitable payment network, channel, or mechanism.

The service 104 can communicate, over one or more networks, with any suitable number of institution computing devices 120. Each device 120, or cluster of devices 120, can be operated by or otherwise associated with an institution such as a bank, brokerage, or other type of (e.g., financial) institution. The device(s) 120 can provide services to entity computing devices 122 that are each operated by or otherwise associated with an entity, such as a customer of the corresponding institution. For example, entities can include potential buyers and/or sellers who seek to participate in trades or other types of transactions through the dark pool provided by the platform. The institutions may be participants in the dark pool, and may agree to abide by the rules and/or other terms for participation. As described above, the platform provides a dark pool in which multiple, different institutions (e.g., banks) can participate, thus increasing the number of potential trading entities and/or potentially traded assets to be exchanged through the dark pool. The platform also ensures the confidentiality and security of the various institutions' information provided to participate in the dark pool, through use of the DLS 112.

Entities can interact with their individual institutions, which may submit buy requests and sell offers to the service 104 on behalf of their entities (e.g., customers). The service 104 can analyze incoming buy requests and sell offers, and check that they comply with the rules 108 governing participation in the dark pool. If the buy requests and sell offers comply, the service 104 can add corresponding request record(s) 114 and offer record(s) 116 respectively to be stored on the DLS 112. A request record 114 can describe a particular buy request, and an offer record 116 can describe a particular sell offer.

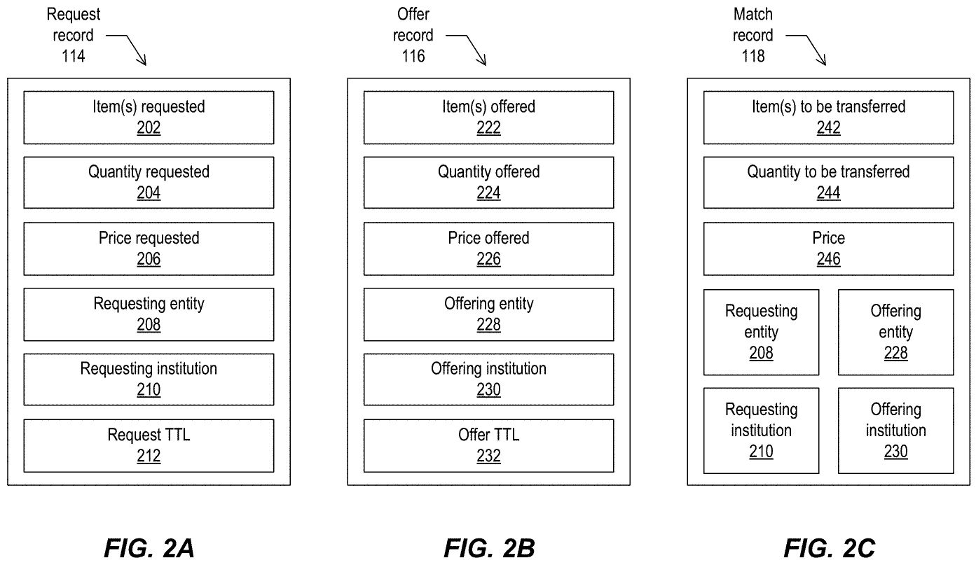

FIG. 2A depicts an example request record 114, according to implementations of the present disclosure. A request record 114 can include, but is not limited to, the following information: item(s) requested 202, describing the type of item to be purchased (e.g., a particular stock, commodity, security, etc.); the quantity of items requested 204 (e.g., number of shares, etc.); the requested purchase price 206; the requesting entity 208 (e.g., the buyer); and the requesting institution 210 (e.g., the buy-side bank, brokerage, etc.). In some implementations, the record can also include a request time-to-live (TTL) 212, indicating how long the buy request is to remain active (e.g., able to be fulfilled through matching to seller(s)). The record can also include other information such as a timestamp (e.g., date and/or time when the request was received and/or record written), a unique identifier of the record, and so forth.

FIG. 2B depicts an example offer record 116, according to implementations of the present disclosure. An offer record 116 can include, but is not limited to, the following information: item(s) offered 222, describing the type of item to be sold (e.g., a particular stock, commodity, security, etc.); the quantity of items offered 224 (e.g., number of shares, etc.); the sale price 226 being offered; the offering entity 228 (e.g., the seller); and the offering institution 230 (e.g., the sell-side bank, brokerage, etc.). In some implementations, the offering entity and/or institution can be anonymized. In some implementations, the record can also include a request time-to-live (TTL) 232, indicating how long the buy offer is to remain active (e.g., able to be fulfilled through matching to buyer(s)). The record can also include other information such as a timestamp (e.g., date and/or time when the request was received and/or record written), a unique identifier of the record, and so forth.

On receiving a buy request, the service 104 can write the request record 114 and search the DLS 112 for sell offers corresponding to the buy request. The matching engine 106 can search the DLS 112 for offer record(s) 116, and attempt to find an offer record 116 that indicates an offer to sell the requested type of item in the requested number. In some instances, the matching engine 106 can assemble a set of offer records that, taken together, provide a total number of items for sale corresponding to the requested quantity of items to be bought by the buyer. If the matching engine 106 is able to match a buy request with the appropriate sell offer(s), to assemble the requested quantity of items to be purchased, a match record 118 can be written to the DLS 112 describing the match. A match notification can be sent to the buyer's and seller(s)' institutions, indicating the match and identifying the entities who have been identified as potential buyer and seller(s), to participate in the transaction. The institutions can then notify the appropriate entities (buyer and seller(s)), and thus facilitate the completion of the transaction through whatever clearing mechanism is appropriate.

FIG. 2C depicts an example match record 118, according to implementations of the present disclosure. A match record 118 can include, but is not limited to, the following information: the particular item(s) to be transferred 242 (e.g., identifying the particular stock or security to be traded); the quantity of items to be transferred 244 (e.g., number of shares, etc.); the price 246 for the transaction; the requesting entity (208) (e.g., the buyer); the offering entity 228 (e.g., the seller); the requesting institution 210 (e.g., the buy-side bank, brokerage, etc.); and the offering institution 230 (e.g., the sell-side bank, brokerage, etc.). In some implementations, the entity and/or institution information can be anonymized. The record can also include other information such as a timestamp (e.g., date and/or time when the request was received and/or record written), a unique identifier of the record, and so forth.

In some instances, the matched price 246 for the transaction can be the buyer's proposed price 206 and/or the seller's proposed price 226. In instances where multiple sell offers are being assembled to make the trade, the price 246 can be an aggregate (e.g., total sum) of the offer prices 226 for the individual sell offers within the aggregate set of sell offers.

For entities who seek to trade a large number of items (e.g., stock shares, securities, etc.), conducting such a trade using a traditional market could impact the price of the item and otherwise affect other entities' behaviors based on their perceiving of such a large order. The platform provides a dark pool that enables (e.g., large) order execution outside of a traditional market or exchange by identifying and matching buyers and sellers for transactions between entities without soliciting such a sale on a traditional market. The platform provides a transaction mechanism that is less likely to impact a broader market, and may achieve a better price for the entities involved through avoidance of traditional market trading commissions. Use of the DLS with the dark pool preserves anonymity and data confidentiality.

Traditional dark pools are vulnerable to undesirable practices, such as the probing described above to determine market movements and develop trading strategies, e.g., by proposing trades into the traditional dark pool, and jump out ahead of detected trading movements and engage in predatory pricing. Thus traditional dark pools entail risk of bad behavior and of potential regulatory compliance problems. Traditional dark pools are also typically limited to one institution (e.g., bank) and limited to the customers of that single institution. The implementations described herein provide a dark pool platform that employs a DLS to match orders anonymously and confidentially, and not allow entities to access the dark pool market information for inappropriate use. Through use of the DLS, implementations provide data confidentiality for participating institutions, thus allowing multiple different institutions to participate, such that all of their entities (e.g., customers) can participate in trades and be eligible for matching. Thus, a particular transaction may be between entities that are customers of different institutions. Since entities of multiple institutions can participate, the DLS implementation increases the likelihood that sellers and buyers are matched, that price volatility is reduced, and that transactions are completed faster as compared to conventional dark pool implementations.

The DLS can be a private DLS that is not accessible to the general public. Accessibility to the platform can be limited to those institutions who join and are eligible to trade items through the platform. Matches can be one buyer to one seller, multiple buyers to one seller, one buyer to multiple sellers, or multiple buyers to multiple sellers.

In some implementations, as described above, the end result of the matching process can be a notification sent to the buyer(s)' and seller(s)' institutions, the notification identifying the particular buyer(s) and seller(s) that have been matched, to enable the transaction to proceed through a suitable clearing mechanism. The notification can also include the price that has been determined for the transaction. In some implementations, the platform can provide functionality that enables the entities and/or their institutions to negotiate the price (e.g., anonymously) prior to completing the transaction. The DLS can be used to store a record of the match and/or the transaction for audit purposes.

In some implementations, the platform can apply a set of rule(s) 108 that govern participation in the dark pool platform. Incoming buy requests and sell offers can be analyzed to check that they comply with the rules, and non-compliance requests and/or offers can be denied. For example, the rule(s) can include a maximum frequency for buy requests and/or sell offers coming into the platform, to attempt to prevent parties from iteratively probing price and/or availability of items on the dark pool to probe market trends. Such rules can provide a throttling of trade frequency that is allowed through the dark pool platform. The rules can specify actions to be taken if non-compliance is detected. For example, the buy order or sell offer can be denied and flagged for further investigation, or the buy order or sell offer can be allowed but flagged for further investigation. Rules compliance and/or non-compliance can be recorded on the DLS for later auditing. Actions taken may be automatic in some instances.

The items traded through the dark pool platform can include any appropriate type of traded items, such as securities, shares in stocks, and so forth. The items traded may, in some instances, be somewhat illiquid securities, such that it may be difficult to find large quantities of such items in traditional markets. By provide a dark pool that facilitates the participation of multiple institutions, implementations may make is easier to trade such typically illiquid assets in large quantities.

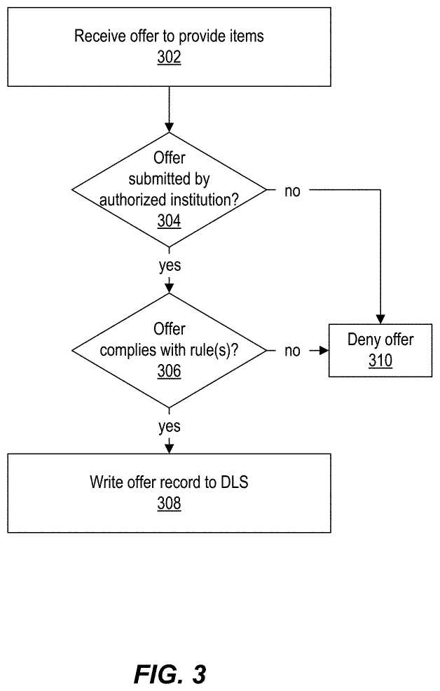

FIG. 3 depicts a flow diagram of an example process for handling offers, according to implementations of the present disclosure. Operations of the process can be performed by one or more of the requesting matching service 104, matching engine 106, the security module(s) 110, the real-time settlement engine 124, and/or other software component(s) executing on the server computing device(s) 102 or elsewhere.

An offer is received (302) to provide (e.g., sell) items. The offer can originate from a seller entity, and be provided to the platform through the seller's institution (e.g., sell-side bank). The offer can indicate the item to be sold, quantity to be sold, proposed sale price, TTL to keep the offer valid and actionable, the identity of the seller, the identity of the seller's institution, and/or other information.

A determination is made (304) whether the offer has been submitted by an authorized institution, such as an institution that is authorized to participate in the dark pool provided by the platform. If so, a determination is made (306) whether the offer complies with the rule(s) 108 governing participation. If so, the offer record is written to the DLS (e.g., stored on the DLS) to be available for subsequent matching operations. If the offer is submitted by an unauthorized institution or otherwise fails to comply with the rule(s) 108, the deny may be denied (310).

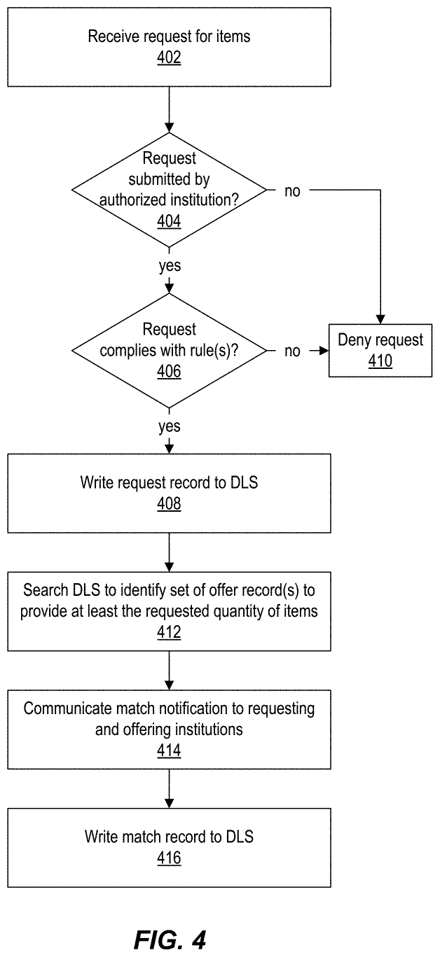

FIG. 4 depicts a flow diagram of an example process for handling requests, according to implementations of the present disclosure. Operations of the process can be performed by one or more of the requesting matching service 104, matching engine 106, the security module(s) 110, the real-time settlement engine 124, and/or other software component(s) executing on the server computing device(s) 102 or elsewhere.

A request is received (402) to receive (e.g., buy) items. The request can originate from a buyer entity, and be provided to the platform through the buyer's institution (e.g., buy-side bank). The request can indicate the item to be received (e.g., bought), quantity to be bought, proposed purchase price, TTL to keep the request valid and actionable, the identity of the buyer, the identity of the buyer's institution, and/or other information.

A determination is made (404) whether the request has been submitted by an authorized institution, such as an institution that is authorized to participate in the dark pool provided by the platform. If so, a determination is made (406) whether the request complies with the rule(s) 108 governing participation. If so, the request record is written to the DLS (e.g., stored on the DLS) to be available for subsequent matching operations. If the request is submitted by an unauthorized institution or otherwise fails to comply with the rule(s) 108, the request may be denied (410).

The platform can search (412) the DLS to identify one or more offer records to provide at least the requested quantity of items described in the buy request. As described above, the match may be with a single seller, or with multiple sellers that, in aggregate, are offering the requested number of items through multiple offers. The match may be based on a correspondence between the requested items and the offered items (e.g., the same stock or security being offered for sale as is being requested for purchase), and a total quantity of the offered items described in the one or more offer records being at least the requested quantity of items. The TTL information for buy and sell can also be checked to make sure that the records have not timed out. Once a match has been determined, the platform can communicate (414) a match notification to the buyer(s)' and seller(s)' institutions, identifying the parties to the transaction. The trade can then be completed through an appropriate clearance mechanism. In some implementations, the platform itself can provide a clearance mechanism that enables the trade to be completed. A match record can also be written (416) to the DLS, as described above.

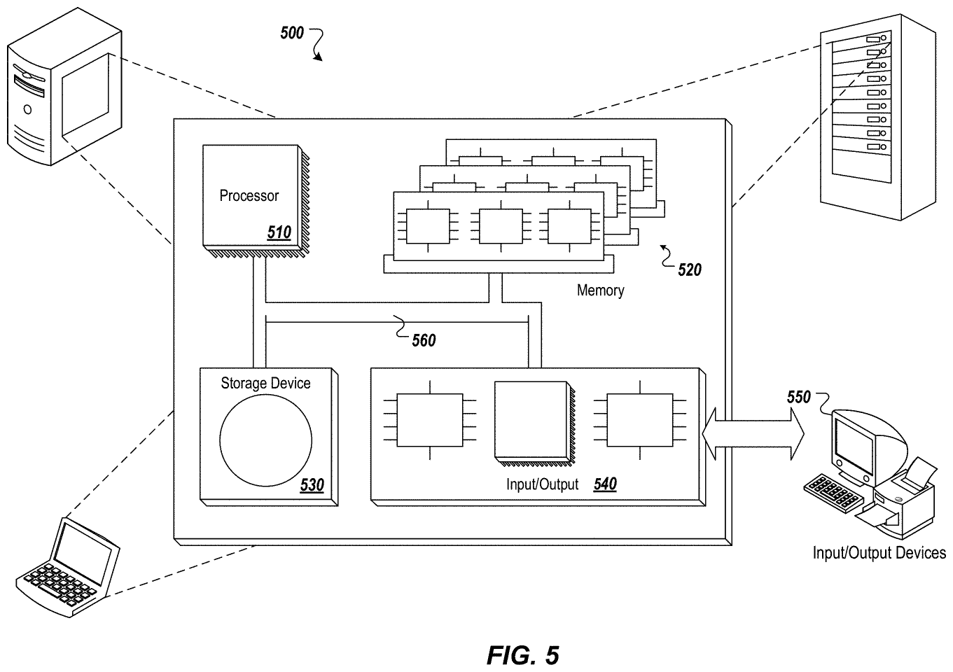

FIG. 5 depicts an example computing system, according to implementations of the present disclosure. The system 500 may be used for any of the operations described with respect to the various implementations discussed herein. For example, the system 500 may be included, at least in part, in one or more of the server computing device(s) 102, the institution computing device(s) 120, the entity computing device(s) 122, the node(s) that host the DLS 112, and/or other computing device(s) or system(s) described herein. The system 500 may include one or more processors 510, a memory 520, one or more storage devices 530, and one or more input/output (I/O) devices 550 controllable via one or more I/O interfaces 540. The various components 510, 520, 530, 540, or 550 may be interconnected via at least one system bus 560, which may enable the transfer of data between the various modules and components of the system 500.

The processor(s) 510 may be configured to process instructions for execution within the system 500. The processor(s) 510 may include single-threaded processor(s), multi-threaded processor(s), or both. The processor(s) 510 may be configured to process instructions stored in the memory 520 or on the storage device(s) 530. For example, the processor(s) 510 may execute instructions for the various software module(s) described herein. The processor(s) 510 may include hardware-based processor(s) each including one or more cores. The processor(s) 510 may include general purpose processor(s), special purpose processor(s), or both.

The memory 520 may store information within the system 500. In some implementations, the memory 520 includes one or more computer-readable media. The memory 520 may include any number of volatile memory units, any number of non-volatile memory units, or both volatile and non-volatile memory units. The memory 520 may include read-only memory, random access memory, or both. In some examples, the memory 520 may be employed as active or physical memory by one or more executing software modules.

The storage device(s) 530 may be configured to provide (e.g., persistent) mass storage for the system 500. In some implementations, the storage device(s) 530 may include one or more computer-readable media. For example, the storage device(s) 530 may include a floppy disk device, a hard disk device, an optical disk device, or a tape device. The storage device(s) 530 may include read-only memory, random access memory, or both. The storage device(s) 530 may include one or more of an internal hard drive, an external hard drive, or a removable drive.

One or both of the memory 520 or the storage device(s) 530 may include one or more computer-readable storage media (CRSM). The CRSM may include one or more of an electronic storage medium, a magnetic storage medium, an optical storage medium, a magneto- optical storage medium, a quantum storage medium, a mechanical computer storage medium, and so forth. The CRSM may provide storage of computer-readable instructions describing data structures, processes, applications, programs, other modules, or other data for the operation of the system 500. In some implementations, the CRSM may include a data store that provides storage of computer-readable instructions or other information in a non-transitory format. The CRSM may be incorporated into the system 500 or may be external with respect to the system 500. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 510 and the memory 520 may be supplemented by, or incorporated into, one or more application-specific integrated circuits (ASICs).

The system 500 may include one or more I/O devices 550. The I/O device(s) 550 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 550 may also include one or more output devices such as a display, LED(s), an audio output device (e.g., a speaker), a printer, a haptic output device, and so forth. The I/O device(s) 550 may be physically incorporated in one or more computing devices of the system 500, or may be external with respect to one or more computing devices of the system 500.

The system 500 may include one or more I/O interfaces 540 to enable components or modules of the system 500 to control, interface with, or otherwise communicate with the I/O device(s) 550. The I/O interface(s) 540 may enable information to be transferred in or out of the system 500, or between components of the system 500, through serial communication, parallel communication, or other types of communication. For example, the I/O interface(s) 540 may comply with a version of the RS-232 standard for serial ports, or with a version of the IEEE 1284 standard for parallel ports. As another example, the I/O interface(s) 540 may be configured to provide a connection over Universal Serial Bus (USB) or Ethernet. In some examples, the I/O interface(s) 540 may be configured to provide a serial connection that is compliant with a version of the IEEE 1394 standard.

The I/O interface(s) 540 may also include one or more network interfaces that enable communications between computing devices in the system 500, or between the system 500 and other network-connected computing systems. The network interface(s) may include one or more network interface controllers (NICs) or other types of transceiver devices configured to send and receive communications over one or more communication networks using any network protocol.

Computing devices of the system 500 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 500 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A method for enhancing data security in a dark pool, the method performed by at least one processor, and the method comprising:
receiving, by a matching service that controls access to a blockchain-based distributed ledger system (DLS) that comprises one or more blockchains and multiple host nodes, offers from a plurality of institutions participating in the dark pool;
for each offer, writing, by the matching service, a record to the DLS, the record describing a respective offer;
receiving, by the matching service, a request to provide items to a requesting entity, the request being received from a first computing device that is operated by a first institution associated with the requesting entity, and the request indicating a requested quantity of the items to be provided to the requesting entity;
in response to receiving the request, verifying that the first institution is authorized to participate in the dark pool;
in response to determining that the first institution is authorized to participate in the dark pool, storing a request record in the DLS, the request record identifying the requested quantity of the items, the requesting entity, and the first institution;
searching, by the matching service, the DLS to identify a set of offer records that includes at least one offer record stored on the DLS, each of the set of offer records describing a respective offer that is available within the dark pool to provide items from a respective offering entity associated with a respective second institution that is authorized to participate in the dark pool, wherein the set of offer records are identified based at least partly on:
i) a correspondence between the requested items and the offered items, and
ii) a total quantity of the offered items described in the set of offer records being at least the requested quantity of items; and
communicating, by the matching service, a match notification to the first computing device operated by the first institution and to one or more second computing devices each operated by respective second institutions identified in the set of offer records, the match notification identifying the requesting entity and one or more offering entities identified in the set of offer records, wherein at least one second institution identified in the set of offer records is different from the first institution associated with the requesting entity.

2. The method of claim 1, wherein:
the DLS stores a plurality of request records that each indicates a respective requested quantity of items, a respective requesting entity, and a respective first institution associated with the respective requesting entity;
the DLS stores a plurality of offer records that each indicates a respective offered quantity of items, a respective offering entity, and a respective second institution associated with the respective offering entity; and
the respective requesting entity, the respective first institution, the respective offering entity, and the respective second institution are anonymized in the request records and the offer records stored on the DLS.

3. The method of claim 1, wherein:
the request record further describes a requested price for the items; and
each offer record further describes an offered price for the items.

4. The method of claim 3, wherein the match notification further indicates an aggregate price based on the offered price described in the set of offer records.

5. The method of claim 1, wherein:
the request record further includes a request time-to-live (TTL); and
each of the set of offer records further includes a respective offer TTL.

6. The method of claim 5, wherein identifying the set of offer records further includes verifying that the respective offer TTL in each of the set of offer records has not expired.

7. The method of claim 1, further comprising:
applying, by the at least one processor, a set of rules that govern access to the DLS, including denying requests from a requesting institution based on the requests exceeding maximum request frequency.

8. The method of claim 1, further comprising:
storing, by the at least one processor, on the DLS, a match record that identifies the requesting entity and the one or more offering entities identified in the set of offer records.

9. The method of claim 1, further comprising:
receiving, by the at least one processor, one or more offers to provide items, each offer received from a respective second computing device that is operated by a second institution associated with a respective offering entity, each offer indicating a respective offered quantity of the items to be provided from the respective offering entity; and
storing, by the at least one processor, on the DLS, one or more offer records that each describes a respective offer, each offer record identifying the respective offered quantity of the items, the respective offering entity, and the respective second institution associated with the respective offering entity.

10. The method of claim 1, wherein:
the set of offer records includes a plurality of offer records; and
the match notification further identifies, for each of a plurality of offering entities identified in the set of offer records, a respective quantity of the items offered by the respective offering entity.

11. A system for enhancing data security in a dark pool, the system comprising:
at least one processor; and
a memory communicatively coupled to the at least one processor, the memory storing instructions which, when executed, cause the at least one processor to perform operations comprising:
receiving, by a matching service that controls access to a blockchain-based distributed ledger system (DLS) that comprises one or more blockchains and multiple host nodes, offers from a plurality of institutions participating in the dark pool;
for each offer, writing, by the matching service, a record to the DLS, the record describing a respective offer;
receiving, by the matching service, a request to provide items to a requesting entity, the request being received from a first computing device that is operated by a first institution associated with the requesting entity, and the request indicating a requested quantity of the items to be provided to the requesting entity;
in response to receiving the request, verifying that the first institution is authorized to participate in the dark pool;
in response to receiving the request, verifying that the first institution is authorized to participate in the dark pool;
in response to determining that the first institution is authorized to participate in the dark pool, storing a request record in the DLS, the request record identifying the requested quantity of the items, the requesting entity, and the first institution;
searching, by the matching service, the DLS to identify a set of offer records that includes at least one offer record stored on the DLS, each of the set of offer records describing a respective offer that is available within the dark pool to provide items from a respective offering entity associated with a respective second institution that is authorized to participate in the dark pool, wherein the set of offer records are identified based at least partly on:
i) a correspondence between the requested items and the offered items, and
ii) a total quantity of the offered items described in the set of offer records being at least the requested quantity of items; and
communicating, by the matching service, a match notification to the first computing device operated by the first institution and to one or more second computing devices each operated by respective second institutions identified in the set of offer records, the match notification identifying the requesting entity and one or more offering entities identified in the set of offer records, wherein at least one second institution identified in the set of offer records is different from the first institution associated with the requesting entity.

12. The system of claim 11, wherein:
the DLS stores a plurality of request records that each indicates a respective requested quantity of items, a respective requesting entity, and a respective first institution associated with the respective requesting entity;
the DLS stores a plurality of offer records that each indicates a respective offered quantity of items, a respective offering entity, and a respective second institution associated with the respective offering entity; and
the respective requesting entity, the respective first institution, the respective offering entity, and the respective second institution are anonymized in the request records and the offer records stored on the DLS.

13. The system of claim 11, wherein:
the request record further describes a requested price for the items; and
each offer record further describes an offered price for the items.

14. The system of claim 13, wherein the match notification further indicates an aggregate price based on the offered price described in the set of offer records.

15. The system of claim 11, wherein:
the request record further includes a request time-to-live (TTL); and
each of the set of offer records further includes a respective offer TTL.

16. The system of claim 15, wherein identifying the set of offer records further includes verifying that the respective offer TTL in each of the set of offer records has not expired.

17. The system of claim 11, the operations further comprising:
applying a set of rules that govern access to the DLS, including denying requests from a requesting institution based on the requests exceeding maximum request frequency.

18. The system of claim 11, the operations further comprising:
storing, on the DLS, a match record that identifies the requesting entity and the one or more offering entities identified in the set of offer records.

19. The system of claim 11, the operations further comprising:
receiving one or more offers to provide items, each offer received from a respective second computing device that is operated by a second institution associated with a respective offering entity, each offer indicating a respective offered quantity of the items to be provided from the respective offering entity; and
storing, on the DLS, one or more offer records that each describes a respective offer, each offer record identifying the respective offered quantity of the items, the respective offering entity, and the respective second institution associated with the respective offering entity.

20. One or more non-transitory computer-readable storage media storing instructions which, when executed, cause at least one processor to perform operations comprising:
receiving, by a matching service that controls access to a blockchain-based distributed ledger system (DLS) that comprises one or more blockchains and multiple host nodes, offers from a plurality of institutions participating in the dark pool;
for each offer, writing, by the matching service, a record to the DLS, the record describing a respective offer;
receiving, by the matching service, a request to provide items to a requesting entity, the request being received from a first computing device that is operated by a first institution associated with the requesting entity, and the request indicating a requested quantity of the items to be provided to the requesting entity;
in response to receiving the request, verifying that the first institution is authorized to participate in the dark pool;
in response to receiving the request, verifying that the first institution is authorized to participate in the dark pool;
in response to determining that the first institution is authorized to participate in the dark pool, storing a request record in the DLS, the request record identifying the requested quantity of the items, the requesting entity, and the first institution;
searching, by the matching service, the DLS to identify a set of offer records that includes at least one offer record stored on the DLS, each of the set of offer records describing a respective offer that is available within the dark pool to provide items from a respective offering entity associated with a respective second institution that is authorized to participate in the dark pool, wherein the set of offer records are identified based at least partly on:
i) a correspondence between the requested items and the offered items, and
ii) a total quantity of the offered items described in the set of offer records being at least the requested quantity of items; and
communicating, by the matching service, a match notification to the first computing device operated by the first institution and to one or more second computing devices each operated by respective second institutions identified in the set of offer records, the match notification identifying the requesting entity and one or more offering entities identified in the set of offer records, wherein at least one second institution identified in the set of offer records is different from the first institution associated with the requesting entity.
